(19) United States
(12) Patent Application Publication
(10) Pub. No.: US 2003/0028786 A1
(43) Pub. Date: Feb. 6, 2003

(54) System and method for software anti-piracy licensing and distribution

(76) Inventor: Shakeel Mustafa, Tustin, CA (US)

Correspondence Address: Shakeel Mustafa, 15520 Tustin Village Way # 2, Tustin, CA, 92780, US

(21) Appl. No.: 09/915,255

(22) Filed: Jul. 26, 2001

(51) Int. Cl. H04L 9/00

(52) U.S. Cl. 713/189; 705/59

(57) ABSTRACT

The present invention provides a new and novel system and method for protecting a computer software product from its unauthorized use. In a preferred embodiment of the invention, a computer system or any other processor based hardware must ‘download’ a credit from an authorized licensing system in order to operate a software product. The invention also provides a novel way of utilizing dynamic encryption techniques that are used to exchange credits. The dynamic encryption techniques ensure that the licensing credits exchange taking place between the computer system and licensing system in the form of binary bit segments appear to be ‘random’ in nature. The credits are transferable from one form of licensing system to another licensing system adapted in a different embodiment. The licensing system also provides a convenient way to add or subtract the number of available credits in it. In the event a hard drive containing a software program fails to operate then the licensing system has the ability to ‘recover’ the installation credit from the failed hard drive available for the use of another software product installation.

### BACKGROUND OF THE INVENTION

Software is one of the most valuable technologies of the Information Age, running everything from PCs to the Internet. Unfortunately, because software is so valuable, and because computers make it easy to create an exact copy of a program in seconds, software piracy is widespread. From individual computer users to professionals who deal wholesale in stolen software, piracy exists in homes, schools, businesses and government. Software pirates not only steal from the companies that make the software, but with less money for research and development of new software, all users are hurt. That's why all software piracy—even one copy you make for a friend—is illegal. As the number of PCs and Internet use grow, the incidence of software piracy is growing, too.

In technical literature, including patents, a number of innovative techniques have been disclosed to prevent software piracy. In one technique software protection requires the user to utilize a secret code or password which must be obtained from the software supplier and entered when using the software. However, this approach still does not preclude unauthorized copying since the code or password can be obtained by one person and can be given to many other users.

U.S. Pat. No. 5,199,066 discloses a method and system for protecting software from unauthorized copying. The method utilizes input of both the hardware code corresponding to the hardware on which the software is to run and a software code for the particular embodiment of the software. It uses both operating codes to yield an intermediate code. Depending upon the intermediate code the software execution is permitted or rejected.

Other forms of software protection have been developed and employed with limited success, In some cases, the other forms of protection are too expensive to employ with some software. In other cases, these other forms of protection are not technically suitable for some software.

Despite this prior art, the need exists for an invention that can provide for distributing software to users and allowing the users to conveniently install and use the software while, at the same time, protecting the interests of the software suppliers by preventing the unauthorized use of the software.

### SUMMARY OF THE INVENTION

To achieve the foregoing and other objects and in accordance with the purpose of the present invention, a software licensing and distribution system is disclosed. The proposed licensing system can communicate with a computer system in many different ways. A licensing system can be embodied in a hardware based dongle that plugs into any peripheral port of a computer system. In another embodiment the licensing system can reside on a remote computer e.g., Web Server, and can be accessed through a network, e.g., the Internet. Yet in another embodiment, the licensing system can be placed on a LAN server and can be accessed via a LAN network. Each of these options presents an environment that best suits a user's preferences. A software product must obtain permission or credit from the licensing system prior to its execution or installation on a computer system. The discussion presented in the disclosure concentrates on the procedures mandated by the licensing system for the installation/un-installation of a software product on a computer system. Nevertheless, the same procedures described herein can also be utilized to provide restricted and time dependent access. Also, the said method can monitor the number of times a software product is permitted to be executed on a computer system.

According to one aspect of the invention, the computer system and the licensing system uses a dynamic encryption method for communication and credits exchange. In the dynamic encryption method both the computer and the licensing system independently generate and exchange a set of random numbers that are used for encrypting data during a particular communication session. The dynamic encryption guarantees that the same data information is encrypted differently every time a new encryption session is established. This scheme prevents any hacker from capturing the encrypted information from one session and then re-playing or re-transmiting later the same information in another session.

The software product that needs to be launched or installed on a computer system initially transmits a random portion of its distinct serial number that is dynamically encrypted to the licensing system. The transmitted random portion carries enough information to uniquely identify itself with the licensing system. The licensing system identifies the unique serial number and consults its database to determine the number of installation credits allowed or left for the software product installation. If the licensing system determines that there are installation credits available it then decrements a single installation credit from the credit pool, logs the entry, and sends back another portion of the serial number to the computer system. The said transmission of the portion of the serial number is also dynamically encrypted and represents an installation credit to the computer system. On the other hand, if the licensing system determines that there is no installation credit left, it then generates an error message and transmits back to the computer system. Unless the software product receives a valid portion of its unique serial number in the proper dynamic encrypted form from the licensing system, it locks itself and refuses to launch or install on the computer system.

In the event an existing software product on a computer system needs to be uninstalled, it again communicates with the licensing system and requests for an installation credit to be granted and added back to the credit pool. Upon receiving the request, the licensing system adds a credit in the credit pool and sends back the confirmation to the computer system. The software product proceeds with its un-installation as it receives the confirmation from the licensing system. The credit added at the licensing system is available next time the software product needs to be installed on the same or a new computer system.

The licensing system with its unique operation always ensures that the number of times a software product is allowed to be installed or launched on different computer systems cannot exceed the total number of licenses (credits) granted or permitted. In addition, the credits are transferable from one type of licensing system to another. For example, a user can “download” the number of allowed credits available at the licensing system installed on the web server to a stand alone licensing system embodied in the form of a hardware dongle. This gives a user flexibility to install or execute a software product on a stand alone computer which does not have access to a network but can readily provide a port where a dongle can be interfaced.

In addition, a licensing system can also ‘recover’ an installation credit(s) from a hard drive which contains a software product but becomes non-functional. By interfacing at the sector level of the non-functional hard drive, the licensing system writes specific patterns of information on pre-determined locations of sectors on the hard drive. This arrangement essentially makes the software product to become unusable on the said hard drive. Once the licensing system verifies the completion of the procedure it adds an installation credit into the credit pool which can be available next time the software product needs to be installed on the same or another computer system.

### BRIEF DESCRIPTION OF THE DRAWINGS

Other objects and advantages of this invention will become readily apparent as the invention is better understood by reference to the accompanying drawings and the detailed description that follows.

FIG. 1A illustrates different possible embodiments of the licensing system.

FIG. 1B shows a licensing system embodied in the form of a dongle communicating with the computer system.

FIG. 2 is a flow diagram illustrating the interaction and operation of the computer system with the licensing system.

FIG. 3A shows initialization for an encrypted communication session between the computer system and the licensing system.

FIG. 3B illustrates the exchange of a random portion of the serial number between the licensing system and the computer system.

FIG. 3C shows the exchange of selective portion of the serial number between the licensing system and the computer system.

FIG. 4A shows a variable size random number containing a pre-determined number of bits located at pre-determined locations within the said random number, representing Function Bits, with respect to the defined boundaries.

FIG. 4B is a table showing all the possible numeric Function Numbers along with their corresponding association with the logical and mathematical functions

FIGS. 5A and 5B illustrate an example of a function operation and its inverse function operation on an information segment.

FIG. 6 depicts the dynamic encryption technique using the random number and a set of logical and mathematical functions.

FIG. 7 illustrates the dynamic decryption technique utilizing the random number and the inverse logical and mathematical functions.

FIG. 8 is a flow diagram showing the establishment of a dynamic encryption session through the exchange of random numbers.

FIG. 9 is flow diagram illustrating the steps for receiving and processing the data at the computer system.

FIG. 10 is a flow diagram showing the steps for verifying the data information received from the licensing system.

FIG. 11 is a flow diagram executed at the licensing system to exchange random numbers in order to establish an encryption session with the computer system.

FIG. 12 is a flowchart executed at the licensing system to provide permission to the computer system to install the software product.

FIG. 13 is a flowchart executed at the licensing system for verifying the installation request from the computer system.

FIG. 14 is a flow diagram executed at the computer system for requesting credit from the licensing system for un-installation of a software product.

FIG. 15 is a flow diagram executed at the licensing system for incrementing credits in response to an un-installation of the software product performed at the computer system.

FIG. 16 is the continuation of the flow chart from FIG. 15

FIG. 17A is a flow diagram executed at the computer system to generate fictitious processors.

FIG. 17 B is a flow diagram executed at the licensing system to filter out any fictitious communication taking place between licensing system and computer systems.

FIG. 18 illustrates a computer system and licensing system interacting in a LAN environment.

FIG. 19 shows procedures to recover the installation credit belonging to a software product from a partially failed hard drive of a computer system.

### DETAILED DESCRIPTION OF THE INVENTION

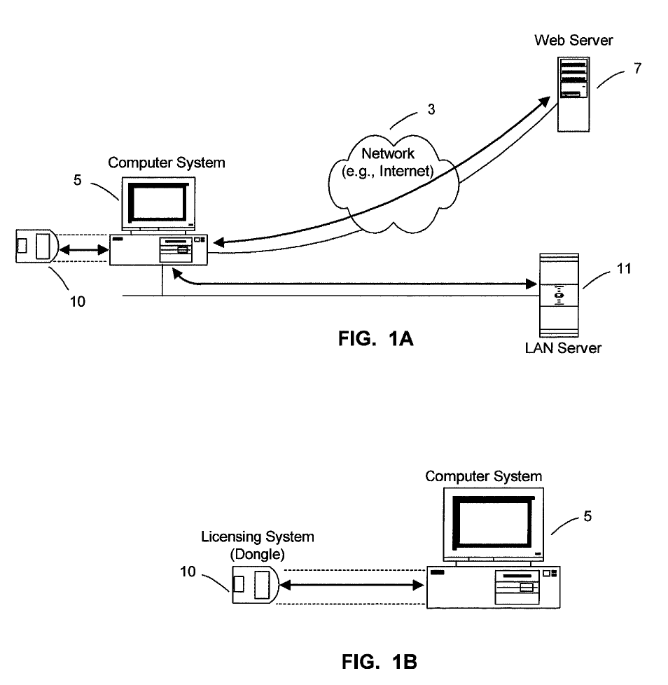

FIG. 1A illustrates different methods for interfacing the proposed licensing system with the computer system 5. A hardware licensing system built in the form of a dongle 10 can be directly interfaced with any available auxiliary (input/output) port of the computer system 10. In a second embodiment, the functionality of the licensing system can reside on a Web Server 7 in the form of a software program. The computer system 5 can access the licensing system residing on the Web Server 7 through a network, e.g., Internet. In a third embodiment, the licensing system functionality can be installed on a LAN Server 11 and the said computer system can access the LAN Server 11 through a typical LAN connection, e.g., Ethernet, Token Ring, etc. As it should be apparent to one of ordinary skill in the art that there can be other ways to exchange information between a computer system and a licensing system. Nevertheless, any of the these techniques falls under the scope of the presented invention.

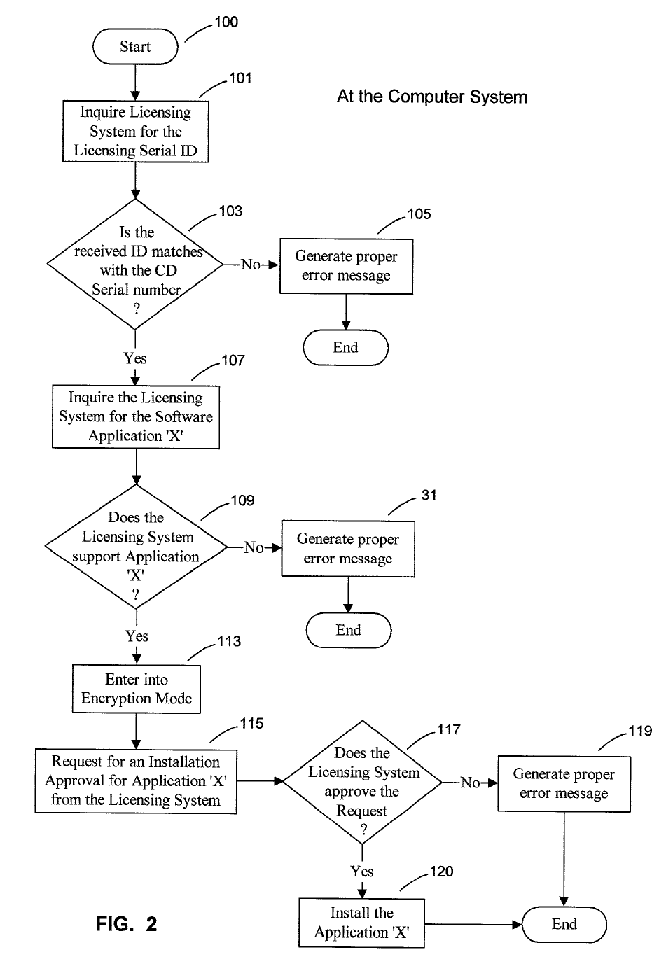

The working mode and the functionality of the licensing system are explained and illustrated with the help of a dongle. FIG. 1B shows the licensing system 10 in the form of dongle which establishes a two way communication session with a computer system 5. As a software product needs to be executed or installed on the computer system 10, the software manager first communicates with the licensing system 10 to obtain credits from the licensing parameters which are mandatory for installation to continue. This procedure is illustrated in FIG. 2, which presents a software flowchart. This flowchart is executed at the computer system. Turning first to step 100 in FIG. 2 which initializes the process. In step 101 the computer system 5 communicates with the licensing system 10 and inquires about the licensing serial number. Then in step 103, the software processor determines whether the received serial number matches with the serial number of the compact disc (CD). If not, it generates a proper error message and terminates the connection. If the received serial number matches with the CD serial number then the software installation processor moves to step 107. In this step the computer system 5 inquires authorization from the licensing system 10 grant permission to install application program ‘X’. In step 109 the computer system 5 processes the reply received from the licensing system 10. If the response indicates the licensing system 10 is authorized to support the software application ‘X’ then the logic moves to step 113. If not, the logic moves to 111 where it generates the error message and terminates the program. On the other hand, if the licensing system is authorized to process the installation request for application ‘X’ the software installation process enters into an encryption session with the licensing system as indicated by step 113. Both the licensing system and installation processor pair up together to exchange messages through their encryption procedures. In step 115 the installation processor requests an installation approval of software application ‘X’ in an encrypted form. The installation processor examines the response from the licensing system in step 117. If the installation request is approved then the installation processor proceeds with the installation of the application ‘X’ in step 120. If the request is denied it generates the proper error message on step 119 and terminates the processor.

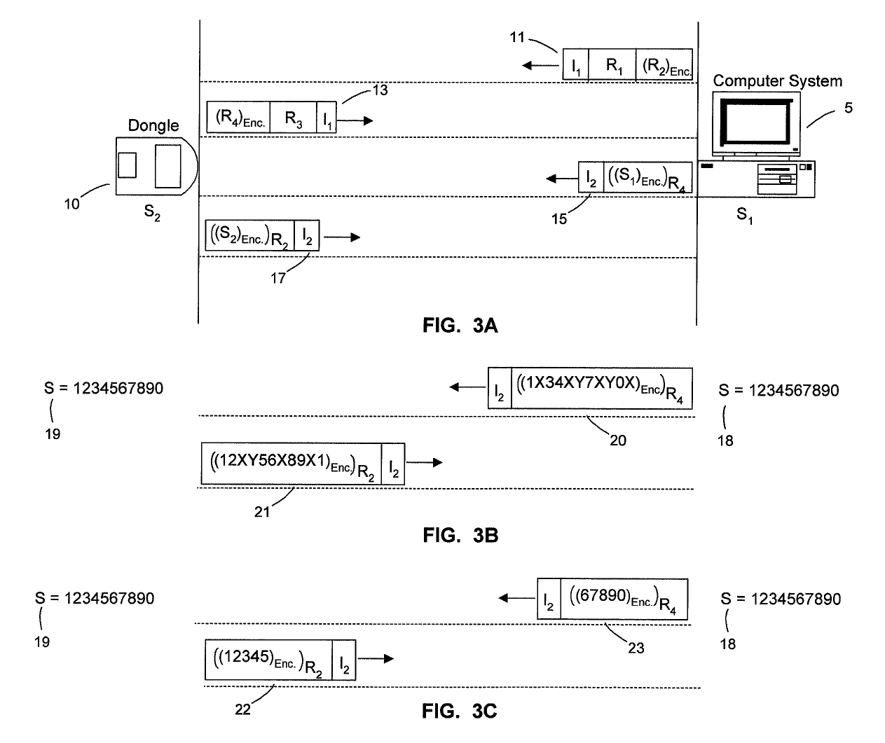

The computer system 5 and the licensing system 10 must utilize a communication technique that is very secure and guarantees that an unauthorized person cannot duplicate or replicate the information necessary for mutual authentication. The present invention presents a unique method of dynamic encryption between the said computer system and the licensing system. FIG. 3A illustrates a typical session for exchanging information between a licensing system e.g. dongle, and software manager e.g., computer system. As a first step, the computer system 5 generates two random numbers, R1 and R2. The said computer system encrypts R2 through R1, appends an identifying instruction I₁ and transmits it to the licensing system 10 in a data packet 11. The unique procedures for encryption are discussed in detail in later sections. The licensing system 10 also generates two random numbers R3 and R4, encrypts R4 through R3, appends instruction field I1 and transmits the resulting packet 13 to the computer system 5. Any further and subsequent data communication exchange between the computer system 5 and licensing system 10 takes place in an encrypted format. The computer system 5 encrypts any outgoing data through the use of R4 while the licensing system 10 encrypts any data destined to the computer system 5 through R2. For example, a data segment S1 is encrypted through R4 and is transmitted in the packet 15. Likewise, the licensing system 10 encrypts S2 through R2 and transmits it to the computer system in the packet 17.

FIG. 3B illustrates a technique that represents the exchange of serial numbers between the computer system 5 and the licensing system 10 for mutual authentication. In this technique a randomly selected portion of the serial number 19 commonly shared by the software manager at the computer system 5 and its corresponding licensing system 10 is exchanged in an encrypted format. The software manger running at the computer system 5 selects a random number of bytes from the serial number 19. The bytes that are not selected out of the serial number 19 are replaced by a known pattern of filler bytes X, Y, etc. The resulting byte array S1 is encrypted through random number R2 and transmitted in a packet 21 along with an instruction identifier to the licensing system 10. The said licensing system decrypts the received number through R2 and compares the bytes, not masked by the filler bytes, with its stored serial number 18. It should be noticed that the serial numbers illustrated as 18 and 19 are essentially the same. If a match occurs then the licensing system 10 generates another serial number S2 which essentially contains the bytes originally masked along with the other bytes. The resulting byte segment is encrypted through using R2 and is transmitted to the computer system in packet 21. On the other hand, if a match does not occur an error message (not shown) is transmitted to the computer system.

FIG. 3C yet illustrates another embodiment in which the computer system 5 encrypts a selective portion of the serial number 18 through R4 and then transmits it to the licensing system 10 in the packet 23. The licensing system 10 decrypts the received portion and compares it with the appropriate portion of the stored serial number 19. If a match occurs, then the licensing system encrypts another selective portion with R2 and transmits it to the computer system 5. If a match does not occur, then it simply transmits an error code or message to the computer system 5.

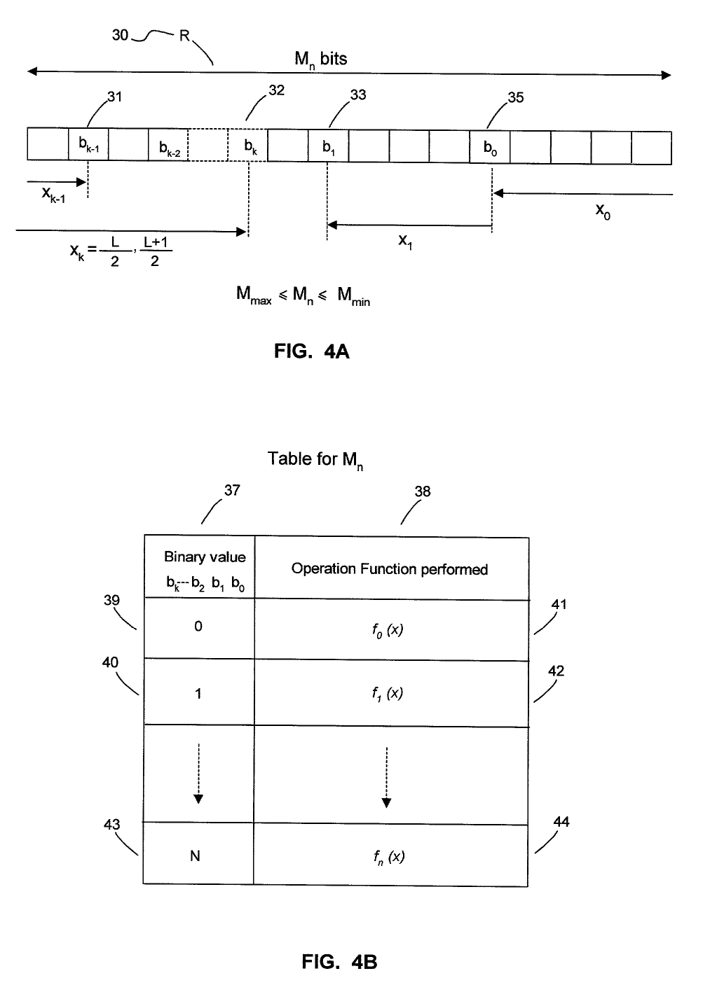

FIG. 4A visually demonstrates the structure of a random number ‘R’ 30 used in conjunction with encryption methods at the individual bit level. The random number ‘R’ 30 can consist of any number of Mₙ bits ranging from a minimum Mₘᵢₙ bits to Mₘₐₓ number of bits. As illustrated in FIG. 4A, the locations of the k number of specific bits b₀ 35, b₁ 33, . . . bₖ 32, known as Function bits, are well defined and recognized in advance by the bit vector distance x₀, x₁, . . . xₙ, respectively. As shown in FIG. 3 the location of the bit b₀ 35 is measured as x₀ number of bits away from the right boundary of the random number ‘R’ 30. Similarly, the location of the next bit b₁ 33 is known to the system as x₁ number of bits away from the bit b₀ 35 position. Further, the system can find the position of the bit bₖ 32 as a bit located exactly in the middle of the random number ‘R’ 30 consisting of length L. As illustrated in FIG. 4A, if the said random number consists of even bits, then the position of the bit bₖ 32 is located as L/2 bits away from the left ending boundary. If the said random number contains an odd number of bits then the bit bₖ 32 position can be identified as (L+1)/2 from the ending boundary.

It should be observed that the location of a Function Bit in the random number ‘R’ 30 can be completely arbitrary. The relationship between a particular Function bit and its corresponding unique location in a given random number can mutually be recognized through the use of any type of pre-negotiated or pre-determined set of rules. The set of rules that are used to identify their unique positions in the random number ‘x’ 30 are shared in advanced by the licensing system 10 and the computer system 5. As both the said licensing system and computer system identify the position of the Function bits, they read the respective bit values and produce the numeric result in the form of a binary Function Number. It is logical to infer that the resulting binary Function Number will be exactly the same at both the said licensing system and installation processor since they both use the same set of rules to identify the Function Bits in the given random number ‘R’ 30.

FIG. 4B maintains this information in a tabular form with column 37 representing all the possible numbers that can be generated by the binary Function Number for a random number of length Mₙ such that Mₘₐₓ<Mₙ<Mₘᵢₙ. In one embodiment, the licensing system and installation processor can maintain multiple tables with each table specifically designed to handle a random number of a particular size. In this case, the total number and the position of each individual bit assigned to represent the role of Function Bits will depend on the length of the random number. This scheme can make it very difficult for an eavesdropper to guess the total number and position of Function Bits since each random number will carry this information differently. The range covered by a binary Function Number depends on the number of bits assigned as Function Bits in a given random number. With 8-bits assigned to Function Bits, the total number of possibilities that a binary Function Number can have spans from 0 to 255.

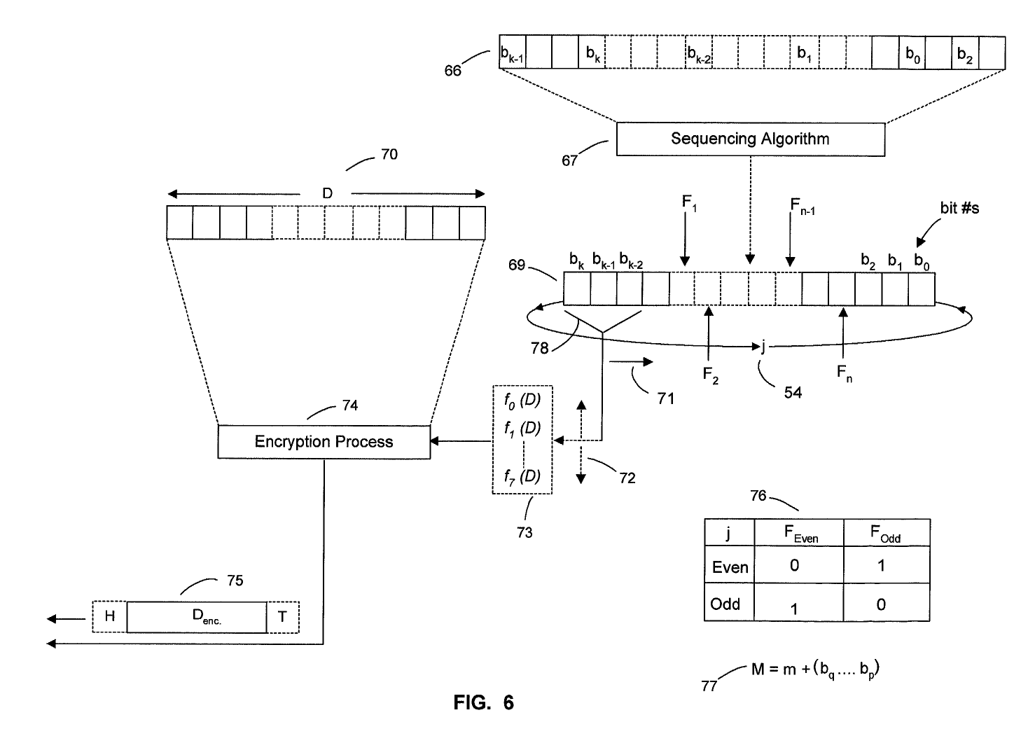

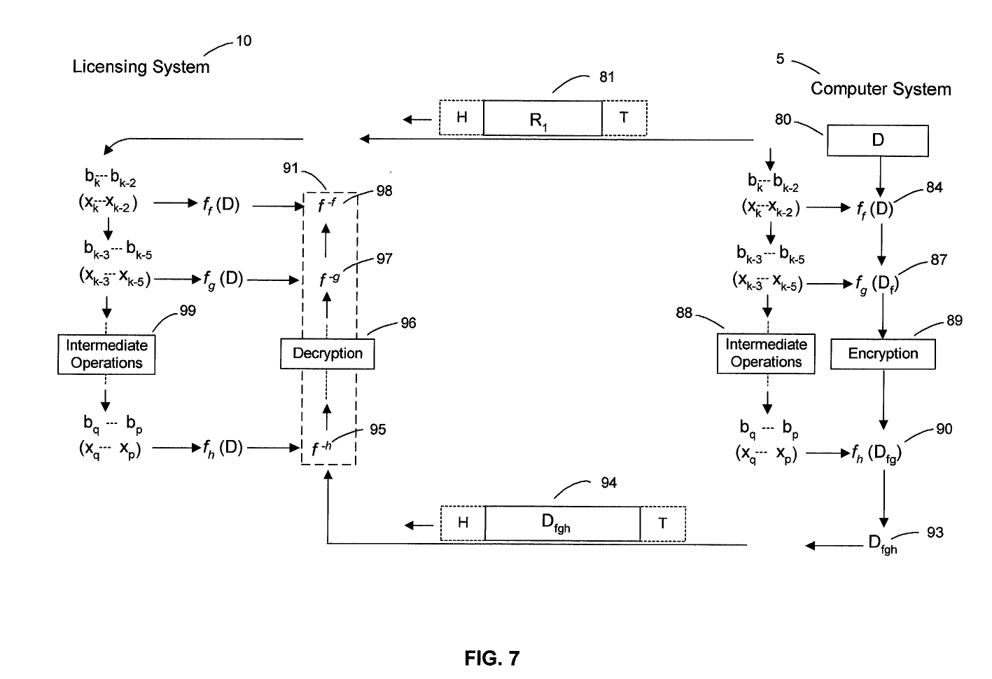

FIG. 4B maintains the range of all the possible numeric values of the binary numbers (bₖ, . . . b₂, b₁, b₀) resulting from a given set of Function Bits in a tabular form as shown in column 37. Each possible binary numeric value uniquely maps to a pre-arranged mathematical or logical function. As illustrated in column 37 of FIG. 6, a resulting binary value of 0 indicated by the table entry 39 corresponds to a mathematical or logical function f₀ (x). Similarly, each resulting numeric value of the Function Bits uniquely corresponds to a single or plurality of the pre-arranged functions. Any mathematical or logical functions of any complexity can be uniquely associated with the binary Function Number with the condition that there exists a unique inverse mathematical or logical function for each of the functions defined.

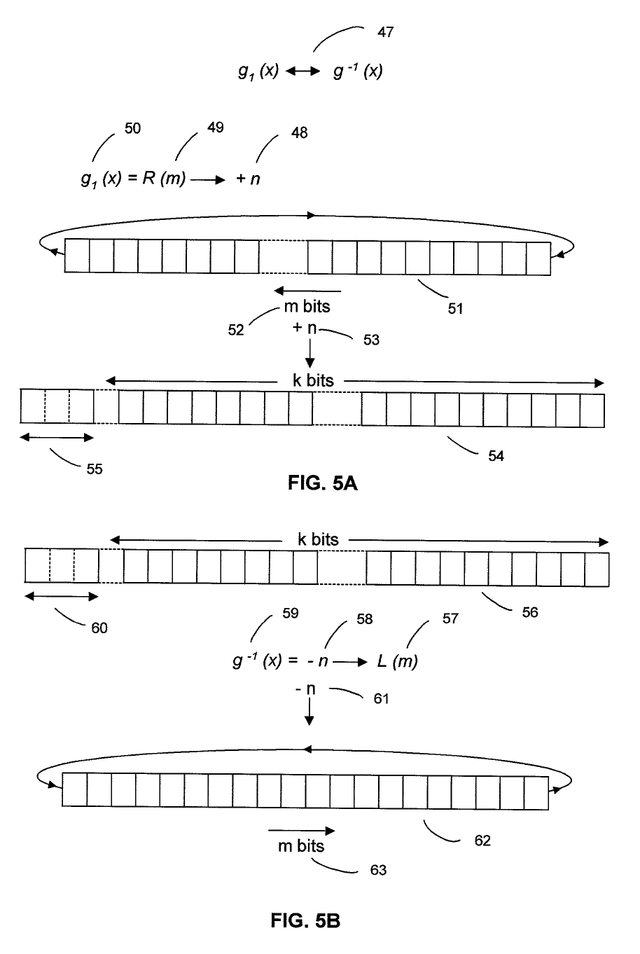

FIGS. 5A and 5B illustrate an example of a function operation followed by its corresponding inverse function operation on a digital information segment of an arbitrary length. In the presented example, the mathematical or logical function g₁ (x) 47 also has its inverse function g⁻¹ (x). The function operation of the function g₁(x) 50 consists of two operators. The first operator R(m) 49 rotates the bits contained in the information segment 51 towards the right to an equivalent number of ‘m’ bits, 52. In the next step, the second operator 48 adds a binary number ‘n’ 53 to the already rotated information segment resulting in an encrypted information segment 54 consisting of k number of bits. It should be observed that depending upon the type of operations performed on the digital information segment the resulting length of the encrypted information segment could be more or less than the original segment. This difference can consist of single or multiple bits. Generally, the digital information is processed and exchanged among the communication layers in term of multiple bytes (8 bits/byte). To ensure that the encrypted information segment consists of multiple bytes, a padding header followed by a certain number of padding bits is appended. As shown in FIG. 5A, the padding header 55 consisting of 3 bits indicates how many padding bits are inserted to make the total encrypted information segment length to be divisible by eight bits or any other number.

FIG. 5B illustrates the operation of the inverse function of g₁(x), represented as g⁻¹(x) 59, on the encrypted information segment 56. The inverse function g⁻¹(x) 175, by its definition, contains all the necessary operators that can reverse the effects of the operations performed by the function g₁(x). In this sense, the inverse function g⁻¹(x) 59 is consists of two operators; the first operator 58 represents a subtraction of number ‘n’ while the second operator 57 represents a left rotation equivalent to ‘m’ number of bits. As the encrypted information segment is processed for decryption the first step is to remove the padding header 60 along with the associated padding bits. Next, the operator 58 subtracts the number ‘n’ from the encrypted information segment 56. As a final step, the operator L(m) 57 rotates the said segment towards the left to an equivalent of ‘m’ bits. The resulting information segment 62 is exactly the same as the information segment 51 before the encryption process. It is evident from this example that the contents of any information segment consisting of any arbitrary length remain unchanged first by the operation of the function g₁ (x) and then by the operation of its inverse function g⁻¹(x).

The above example is presented through the use of simple operators only for the purpose of illustration. Any type of mathematical or logical function or operator of any complexity can be used in this procedure as long as there exists a unique inverse function for any of the selected functions.

FIG. 6 demonstrates the encryption methodology presented in this invention. As an example, the encryption process at the licensing system 10 is explained. The presented encryption method can be either implemented by using software modules or hardware circuits. As a first step, the sequencing algorithm 67 identifies the Function Bits in a received random number 66 from the computer system 10. As a next step, the said licensing system uses the sequencing algorithm 67 to sequentially arrange the Function Bits. The resulting string of bits are transferred to a shift register 69. One objective of the Invention is to present an encryption technique that is very robust, but requires a low hardware cost. To minimize the associated hardware cost only eight different types of mathematical or logical functions are defined in the function pool 73. Before the start of the encryption process the licensing system uses equation 77 to determine the total number of encryption rounds ‘M’. The first part lower case ‘m’ stands for a minimum number of encryption rounds that both the licensing system and its counterpart computer system mutually agree in advance. To make the total number of encryption rounds more dynamic, variable, and unpredictable, a certain number of pre-negotiated bits values in the random number i.e., bq . . . bp, are included. The variable number of encryption rounds will make it extremely difficult for an eavesdropper to know about the total encryption rounds in order to decrypt the data.

As the Function Bits are transferred in the shift register 69 a sliding window selector 78 selects a window containing underneath the first 3 Function Bits (bk bk-1 bk-2) and generates the equivalent binary Function Number which ranges from 0 to 7. As explained earlier with reference to FIG. 4, the resulting Function Number uniquely identifies a corresponding logical or mathematical function ranging between f0 to f7. The selected function from the function pool 73 operates on the data segment ‘D’ 70 that needs to be encrypted in the encryption process 74 and the results are stored in the operational registers of the said encryption process.

For the next encryption round the sliding window selector 78 advances towards the right 71 for an arbitrary number of pre-negotiated bits mutually agreed upon in advance by both the licensing system 10 and the computer system 5. For illustration purposes, it is suggested that the window selector advances three (3) bits towards the right. The resulting Function Bits uniquely produce the binary Function Number which in turn points towards a unique mathematical function defined in the function pool 73. The selected function operates on the already encrypted data from the previous round to further encrypts the data. The sliding window selector 78 continues to slide towards right in three (3) bits increment till it reaches at the end. If the total number of Function Bits populated in the shift register are exact divisible of the integer three (3) then the sliding window 78 ends by selecting b2, b1, b0.

In one preferred embodiment the total number of Function Bits contained in the shift register 69 are selected to be (x/3)−1, where ‘x’ represents an integer divisible by 3. In this implementation, as the sliding window selector 78 reaches at the end, it selects the last two bits b1, b0, and then rotates around to select bk as the third bit, thus forming three (3) bits, b1, b0, bk, to generate the corresponding Function Number. For the second ending cycle the sliding window selector 78 uses b0, bk, bk-1 to produce the corresponding Function Number. At the third ending cycle the sliding window selector 78 now selects the Function Bits b2, b1, b0. The resulting value of the said three Function Bits is used to select the next mathematical function for encryption.

At this time the shift register is barrel rotated counter-clockwise to a pre-determined sequence number ‘j’. It should be noted that the value of the number ‘j’ is pre-negotiated between licensing system 10 and the computer system 5. In a preferred embodiment the number ‘j’ is sequentially incremented by one after a certain number of cycles are executed by the sliding window selector 78.

The shift register 69 also contains ‘n’ number of Bit Injectors, F1, F2 . . . Fn, located at certain and pre-determined bit positions. The function of the Bit Injectors is to modify the bit values at their bit locations after the sliding window selector 78 has completed a certain number of cycles. For example, the table 76 illustrates simple entries where, depending upon the numeric value of ‘j’, even or odd, the bit values underneath the Bit Injectors, Fₑᵥₑₙ or F_{odd}, are selectively modified. This selective alteration in the Function Bits contained by the shift bit register 69 ensures that the resulting Function Numbers dynamically change as the encryption process continues.

The sliding window selector 78 continues to select a sequence of functions from the function pool 73 as it advances through the shift register 69. As the total encryption rounds equal to ‘M’ the encryption process stops and the resulting encrypted data is delivered in the packet format 75 to the computer system 5.

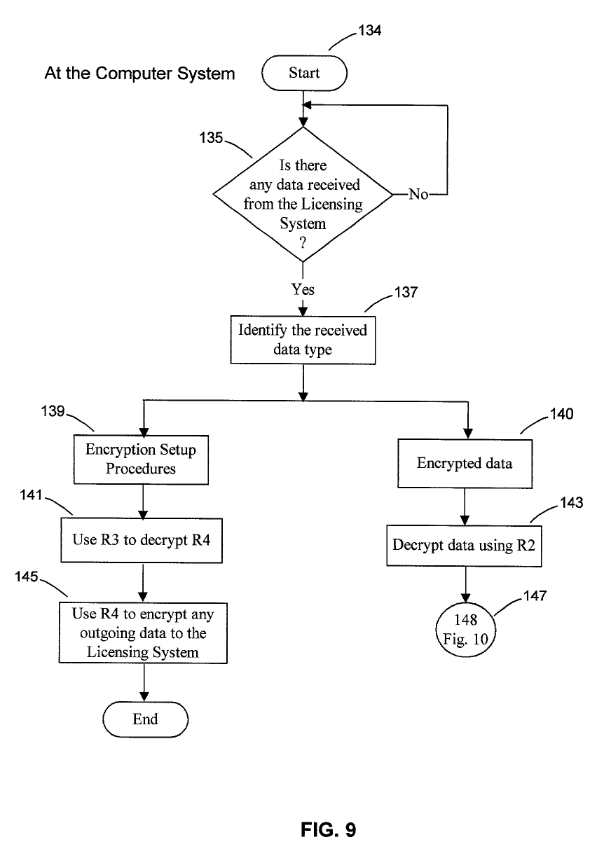

FIG. 9 demonstrates the same encryption methodology with a different functional aspect.. The computer system 5 needs to send a digital information segment 80 consisting of any arbitrary length to the licensing system 10. As discussed previously, both the licensing system 10 and the computer system 5 maintain the exact same configuration parameters to be used for encryption/decryption procedures. As a first step in the encryption procedure, the computer system 5 generates a variable size random number R1 within a given length range of a minimum and maximum number of bits. It should be observed that it is the responsibility of the transport and the lower level communication layers to guarantee the successful delivery of any information exchange between computer system 5 and the licensing system 10. The surrounded header and trailer fields shown in the packet format 81 represent a typical communication overhead added by the lower level of communication layers to process the packet properly for its delivery to the licensing system 10. Therefore, if the packet 94 does not reach the remote licensing system 10 the transport mechanism at the computer system 5 will continue to re-transmit the said packet until it gets a successful notification from its peer transport layer at the licensing system 10.

Both the computer system 5 and licensing system 10 process the random number R1 81. First, both the said systems locate the Function bits (bₙ . . . b₁ b₀) in the random number ‘R1’ 81 using a pre-established set of rules and then determine the resulting binary value of the Function Number as discussed earlier with reference to FIGS. 3 and 4. Since both the said systems are using exactly the same set of rules, they both identify the same binary Function Number value from the said random number R1. The resulting binary Function Number points towards a single function functions as shown previously in FIG. 6 for both said systems. The sliding window selector 78 operates a sequence of function f_{f}, 84 f_{g}, 87 . . . fₕ 90 and the resulting encrypted data segment D_{fgh} 93 is transmitted to the licensing system 10 in a frame format 94. As mentioned earlier, the licensing 10 identifies the inverse functions, i.e., f^{-f}, 98, f^{-g}, 97, f^{-h}, 95, corresponding to each of the functions selected f_{f}, 84 f_{g}, 87 . . . fₕ 90 respectively. The resulting sequence of identified inverse functions (f^{-f}, f^{-g}, f^{-h}) are tabulated in a decrypting function table 91. As the encrypted data segment D_{fgh} is received by the licensing system 10, it selects the inverse function f^{-h}, 95 to remove the encryption from the said data segment as introduced by its counterpart function operation fₕ, 90 at the computer system 5. This process is repeated using all the inverse function entries stored in the decryption function table 91. The intermediate sequence of inverse functions 96, which is equivalent but opposite in operation of the function box 89, further decrypts the received information segment. As the last step, the inverse function entry (f^{-f}, 98) decrypt the information segment and restores the original information data segment, D 80.

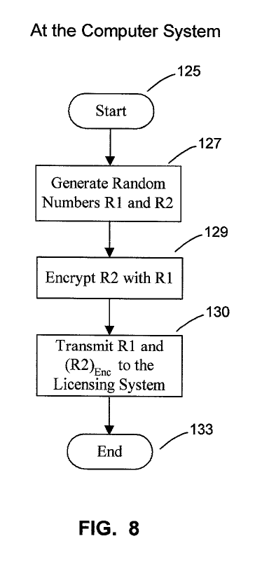

Referring next to FIGS. 8-17B, methods associated with receiving and transmitting communication between the computer system 5 and licensing system 10 will be described. Turing first to FIG. 8, the process takes place by the installation processor running at the computer system 5. The process begins at step 127. In this step, the installation processor generates two random numbers R1 and R2. Using the encryption techniques described previously in reference to FIG. 3, the processor encrypts R2 using R1 as shown in step 129. In step 130 the said computer system transmits R1 along with (R2)_{Enc}. In step 133 the installation processor ends its processing.

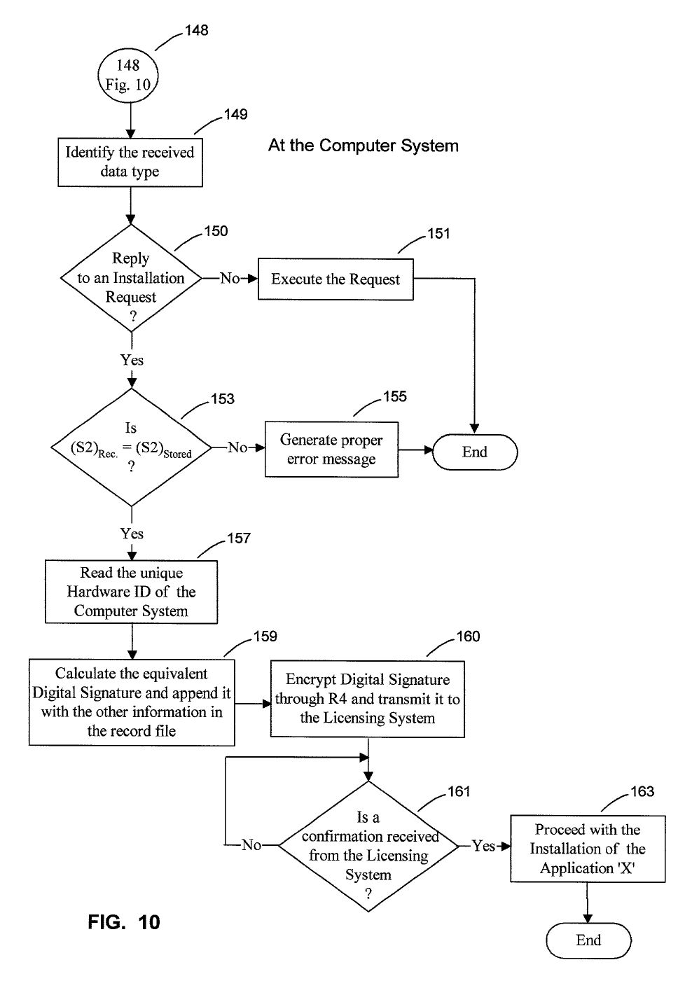

FIG. 9 illustrates the computer system 5 in the receiving mode. In step 135 the computer system actively monitors any communication received from the licensing system 10. If yes, the said Processor identifies the type of received data. If this is encryption setup procedure the logic branches towards step 139. In step 141, the computer system 5 decrypts R4 using R3 and declares R4 as the seed random number that will be used for encryption/decryption procedures in communication with the licensing system 10. In step 145 the computer system uses R4 to encrypt any outgoing data to the licensing system 10. If the received data in step 137 is determined to be encrypted data the processor branches out to step 140. In step 143 the processor decrypts the data using random number R2. The continuation of this processor is illustrated in step 148 of FIG. 10. In step 149 the computer system 5 determines the type of the data received. If the data received is a response to an installation request as determined in step 150 the logic follows to step 153 where it compares the calculated serial number with the received serial number. If these two numbers match then this implies that the licensing system has successfully approved the installation request. If not, the logic moves to step 155 which generates the proper error message that inform the user about the error status and then the installation process ends.

In one preferred embodiment the licensing system 10 can also store a unique digital signature corresponding to the hardware ID of the computer system 5. In this embodiment the computer system 5 reads the unique hardware ID based on different hardware components and then calculates the equivalent digital signature. The said computer system also stores a copy of the digital signature. The said digital signature is encrypted through R4 and is transmitted to the licensing system in step 160. The installation processor being operated at the computer system 5 expects a verification from the licensing system in step 161. Upon receiving a confirmation it proceeds to step 163 where the installation processor proceeds with the installation of software application ‘X’ on the computer system.

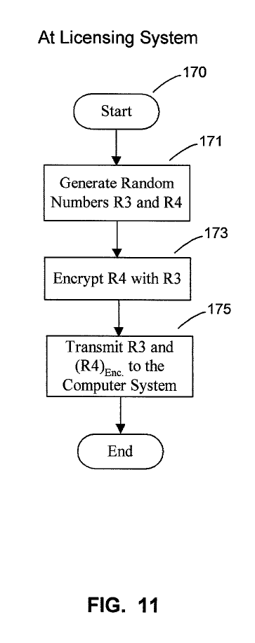

FIG. 11 illustrates the procedure executed at the licensing system 10 for transmitting the random numbers to the computer system 5 which are utilized to establish an encryption session. The licensing system generates two random numbers R3 and R4 as illustrated in step 171. Using the encryption procedures as described earlier, the said licensing system encrypts R4 with R3 in step 173. The resulting random numbers, R3 and (R4)_{Enc} are transmitted to the computer system 5 in step 175.

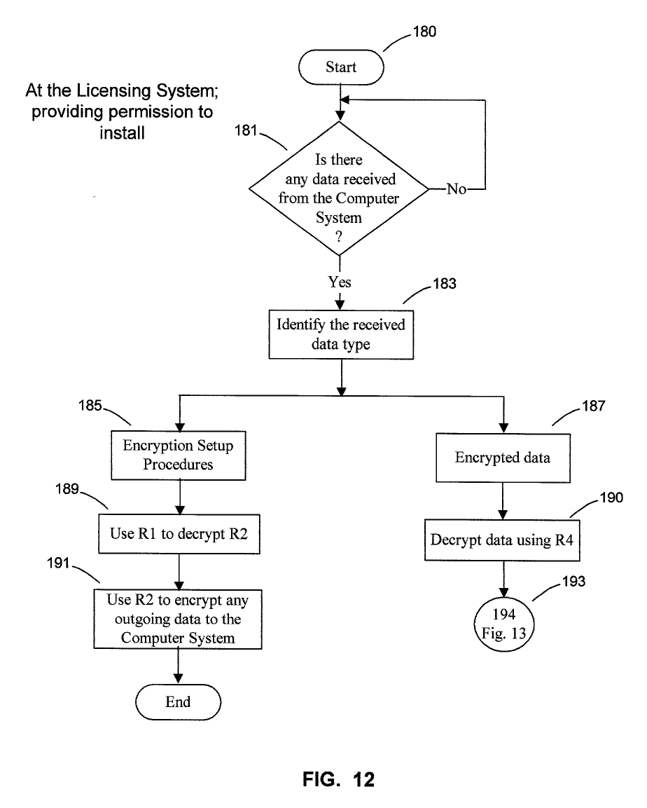

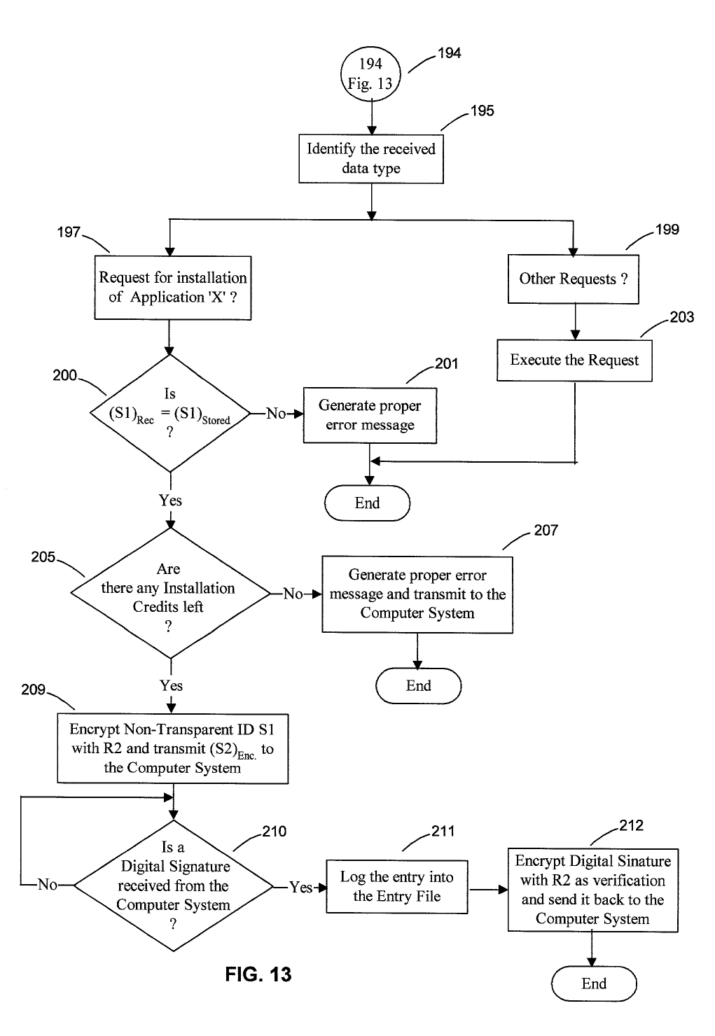

FIG. 12 shows a flowchart that describes the procedures executed at the licensing system for granting permission to install or run the software product at the computer system 5. The process begins at step 180. In step 181 the logic continuously monitors for any type of data received from the computer system 5. If any data is received then in step 183 the said licensing system identifies the type of data. If the received data constitutes encryption setup procedures then the logic flows to step 185. The licensing system decrypts the random number R2 through the use of R1. The random number R2 will be utilized to encrypt any outgoing data to the computer system 5 for the duration of the session. If step 183 determines that the data received is not intended for an encryption session then the logic branches to step 187 where it identifies the type of encrypted data and in step 190 the licensing system decrypts data using the random number R4. FIG. 13 is the continuation of the flow chart from the step 193 of FIG. 12. In step 195 the type of received data is identified. If it is an installation request for software application ‘X’ the logic moves to step 197. In step 200 the licensing system 10 compares the calculated serial number with the received serial number. If these two numbers matches then this implies that the received serial number was generated by an authorized entity, i.e., computer system. If not, the logic moves to step 201 which generates the proper error message or code that informs the user about the error status and following that the installation process ends. In step 205 the licensing system checks for any remaining installation credits provisioned in the said licensing system. In order for an installation request to be approved by the licensing system there must be some installation credits available in the licensing system. If yes, the logic moves to step 209 where an installation credit is decrement from the available credits. As a permission to the computer system to proceed with the installation of software application ‘X’, the licensing system sends the serial number SI encrypted through R2 back to the computer system 5. In one preferred embodiment the licensing system requires the computer system to also transmit a digital signature unique to its hardware. As illustrated in step 210 the logic waits for the digital signature to be received. In the event a time out state occurs (not shown) then the licensing system can also transmit an error message. Upon receiving the digital signature the licensing system logs the digital signature into its Entry File as shown in step 211. In step 212,, the licensing system encrypts the digital signature through using R2 and transmits it back to the computer system 5 as a verification.

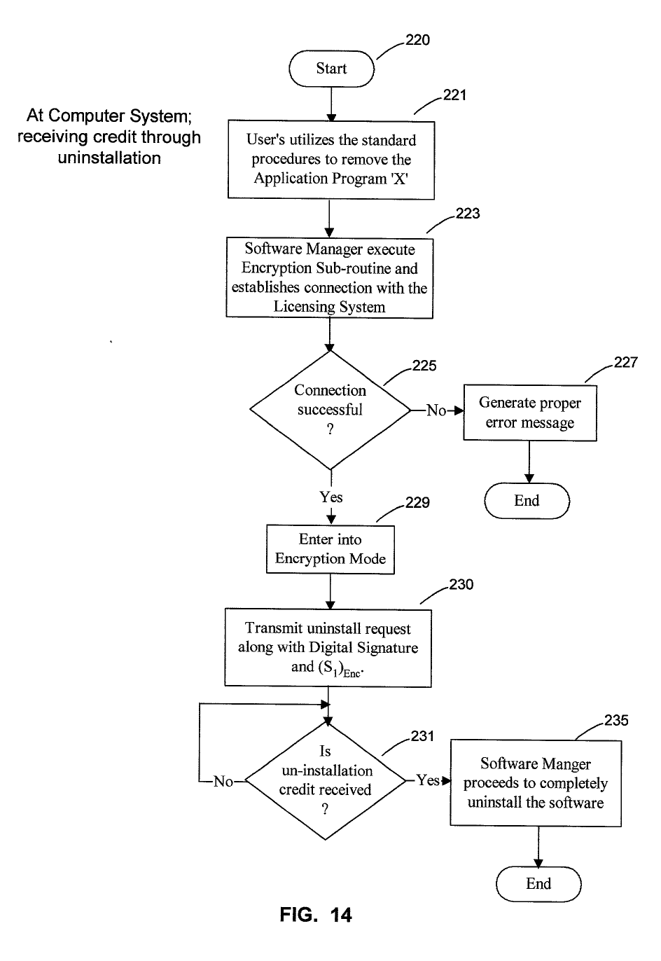

FIG. 14 presents a very unique and innovative feature of this invention for receiving an installation credit from the licensing system 10 by uninstalling the software application ‘X’ from the computer system 5. As a user uninstall the software application ‘X’, its credit is added back to the installation credit pool in the licensing system. The user can reuse this acquired credit to install the software application ‘X’ later on the same computer system or any other computer system. As illustrated in step 221 a user initializes standard procedures to remove the software application ‘X’ from the computer system 5. In step 223 the software application manager executes an encryption sub-routine and establishes a connection with the licensing system 10. Step 225 verifies if a successful connection was established. If yes, the computer system 5 enters into the encryption mode. If not, the software application manager generates an error message alarming the user about the status. In step 230 the software application manager transmits an uninstall request along with the digital signature, if any, and the encrypted part of the serial number (S1)_{Enc}. In step 231 the logic waits for the un-installation credit. If a timeout occurs (not shown) then a proper message can also be generated. In step 235, the software application manager proceeds to completely uninstall the software application ‘X’.

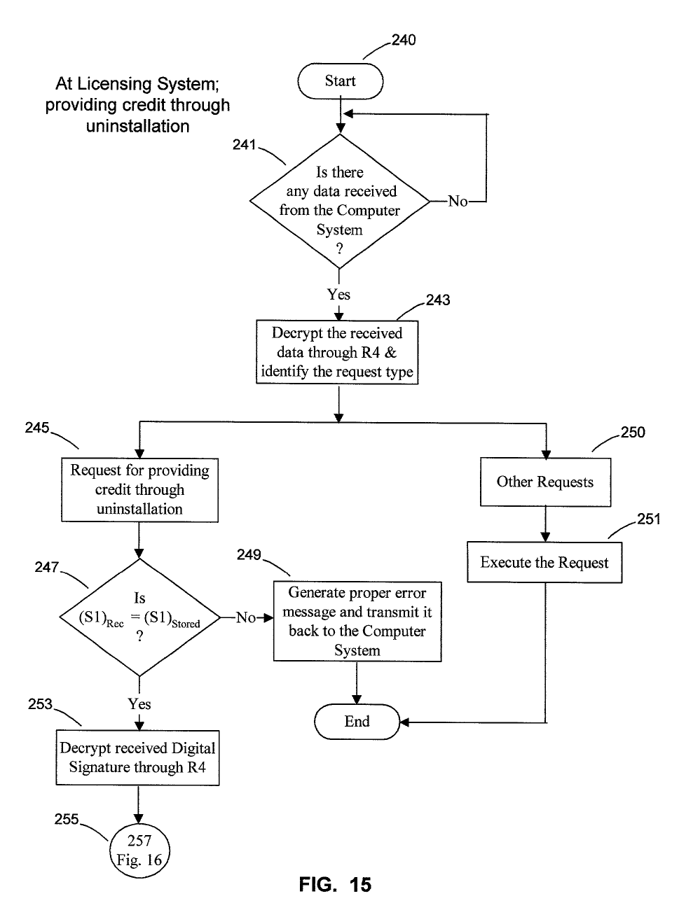

The flowchart illustrated in FIG. 15 shows the method for acquiring an installation credit at the licensing system 10 through un-installing the software application ‘X’ at the computer system 5. In step 241 the licensing system waits for any data to be received from the computer system. In step 243 it decrypts the received data through the random number R2 and identifies the data type. If the request is for acquiring the credit through un-installation then the logic moves to 245. Otherwise, the logic goes to step 250 followed by step 251 where the identified request is executed. In step 247 the licensing system compares the received part of serial number S1 with stored S1 number. If it matches, the logic moves to step 253 where it decrypts the digital signature through R2. If no match is concluded in step 247 the logic moves to 249 where a proper code or message is transmitted back to the computer system 5 and the process ends.

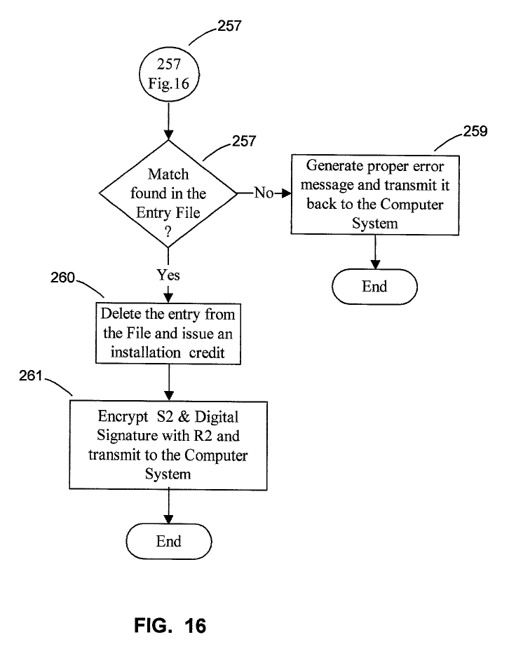

The step 257 as shown in the flowchart of FIG. 16 is a continuation from FIG. 15. In step 257 the licensing system 10 refers to its Entry File to find any matches against the digital signature received. If so, it deletes that particular entry from the file and issues an installation credit as shown in step 260. If not, the licensing system generates the proper code or error message and transmits it back to the computer system 5. In step 261 the licensing system 10 encrypts serial number S2 and the digital signature with R2 and transmits back to the computer system 5. This executed step indicates to the computer system 5 that a proper credit has been issued for uninstalling the software application ‘X’. The received credit can be used for another installation on the same computer system or on any other different computer system.

As it can be concluded from the preceding discussion, the system and method presented in this invention highly relies upon the encryption techniques between the licensing system 10 and the computer system 5 for proper operation. With the advancements of new technology in the software de-bugging techniques it is possible, even though very difficult, that a hacker may debug the encryption methods implemented in software modules in the computer system. To avoid this possibility and to make the software de-bugging process extremely difficult a series of fictitious processors can be simultaneously initialized and run in parallel to each other in the software program. As a result, a hacker may not be able to determine the real processor that is actually communicating with the licensing system 10.

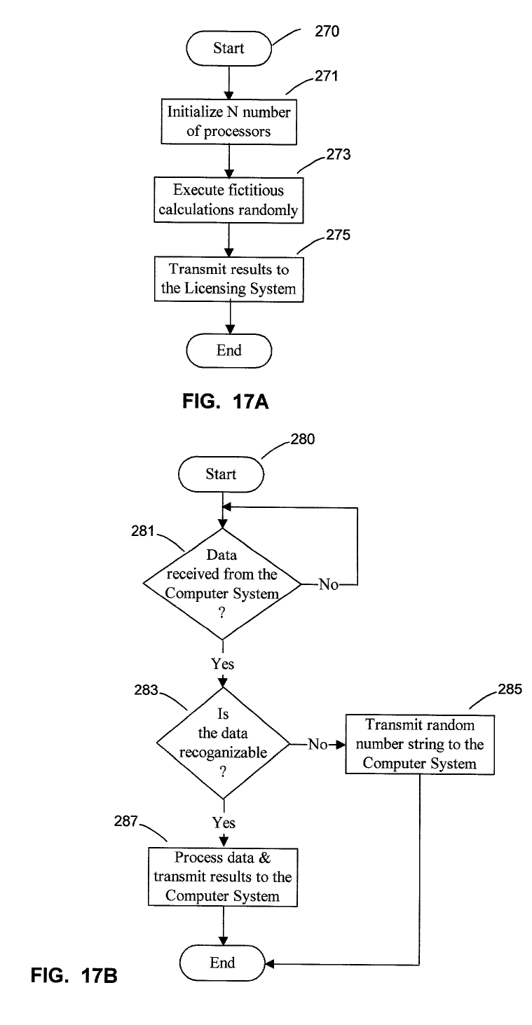

FIG. 17A illustrates the flowchart for this procedure. In step 271, the computer system 5 initializes ‘N’ number of fictitious processors. The number of fictitious processors can be selected in such a way that their continuous execution and processing does not interfere with the computer's vital processing requirements. Step 273 illustrates the random fictitious calculations performed by the computer system 5. In step 275, the computer system 5 randomly transmits these results to the licensing system 10.

FIG. 17B shows the flowchart executed at the licensing system 10 to filter out the fictitious data being received from the computer system. As illustrated in step 281 the licensing system waits for any data to be received from the computer system. In step 283 it tries to recognize the data. If the data is recognizable it proceeds to step 287, where it process the data accordingly and transmit the results back to the computer system 5. On the other hand, if the data is not recognizable in step 283 then the logic moves to step 285 where the licensing system 10 transmits a string of fictitious random numbers to the computer system 5. This presented scheme makes it very difficult for a hacker who might be intercepting the communication between the licensing system and computer system to determine which data constitutes real communication and which one is the fake communication.

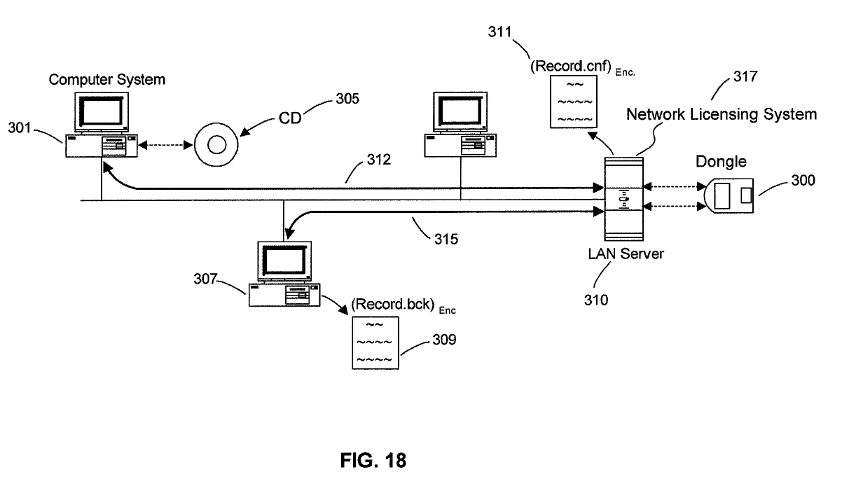

FIG. 18 shows another preferred embodiment of the licensing system 317 being implemented on a LAN Server 310 and used in a LAN environment. In this embodiment the role of the network licensing system 317 is to approve the installation or execution requests of the software application sent by the individual network workstations. In addition, the network licensing system 317 also ensures that the total number of software installations on the network workstations does not exceed the permitted number of installations allowed in a given network. The network licensing system software 317 installed on the LAN server 310 first needs to be independently authenticated by another secured licensing system, e.g., Dongle or Web Server. This will ensure that the same network licensing system software cannot be re-installed on multiple networks.

As illustrated a dongle 300 validates the installation of the network licensing system 317 on the LAN Server 310. The software product application program ‘X’ residing on a Compact Disk (CD) 305 needs to be installed on the computer system 301. As a first step, the said computer system 301 establishes a secure dynamic encryption session with the network licensing system 317 over the LAN connection 312. In accordance with the procedures as described earlier, the software manager running on the computer system 301 sends an installation request to the network licensing system 317. The said network licensing system maintains an internal configuration setup which indicates the maximum number of workstation installations supported by the licensing system in the said LAN. If all the available credits for installation in the licensing system are not exhausted then the said licensing system approves the installation request. Otherwise, the licensing system declines the installation request and sends back an appropriate error message. The network licensing system 317 also maintains a configuration file 311 which contains the current counts of approved installations of the software application ‘X’ on all the workstations in the LAN. In one preferred embodiment, the configuration file 311 contains the digital signatures of the hardware components of the individual workstations in dynamic encrypted form. The licensing system 317 can periodically probe the individual workstations to collect their unique digital signatures. The said licensing system compares the received digital signatures with the digital signatures stored in the configuration file 311. In the event a match does not occur the said licensing system generates a proper message and can also lock the software application ‘X’. For enhanced security and protection a backup configuration file 309 is also retained on workstation 307.

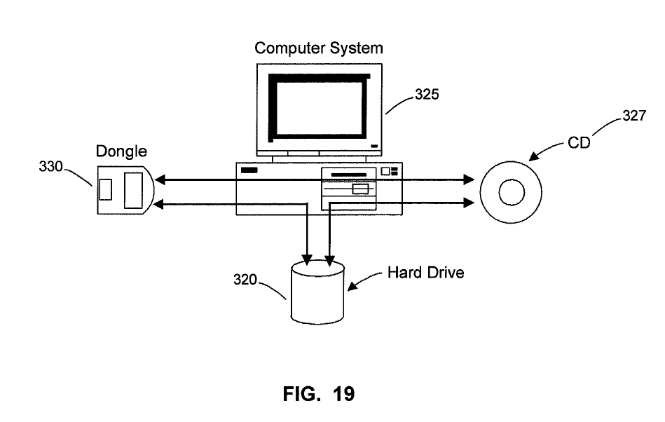

FIG. 19 illustrates a unique arrangement that is used to recover installation or execution credits from a partially failed drive that contained the software product application ‘X’. As illustrated, a failed hard drive 320 is first accessed through an operating system installed on a CD 327 or by any other mechanism. The CD 327, or any other mechanism, also provides the necessary software drivers to establish a communication channel with a licensing system 330. For purposes of illustration, a licensing system in the form of a dongle is described. Any other embodiment of the licensing system can also be used without sacrificing the essential functionality of the presented scheme. The licensing system 330 instructs the operating system, communicating with the hard drive 320, to locate a certain and specific number of sectors on the said hard drive. Next, the licensing system instructs the operating system to write a specific set of data information on the located sectors. The said set of data information ensures that the software application ‘X’ can no longer be operational or executed even the hard drive again becomes functional by using some other salvage methods.

As the next step, the licensing system 330 performs a read operation on the hard drive 320 to verify that the requested set of data was written on the specific sector(s). If verification is successful it issues the proper credit(s) in the credit pool that can be available for the installation or execution of the software application ‘X’ on another computer. If verification is not successful then the licensing system does not issue any credit and instead generates a proper error message for the user.

While the particular invention has been described with reference to illustrative embodiments, this description is not meant to be construed in a limiting sense. It is understood that although the present invention has been described in a preferred embodiment, various modifications of the illustrative embodiments, as well as additional embodiments of the invention, will be apparent to persons skilled in the art upon reference to this description without departing from the spirit of the invention, as recited in the claims appended hereto. Thus, for example, it should be apparent to one of ordinary skill in the art that, the term customer computer is described as a personal computer, such as a desktop or portable computer. However, as used herein, the term “computer” is intended to mean essentially any type of computing device or machine that is capable of running a software product, including such devices as communication devices (e.g., pagers, telephones, electronic books, electronic magazines and newspapers, etc.) and personal and home consumer devices (e.g., home automation systems, handheld computers, multimedia viewing systems, Web-enabled televisions, etc.). Within the described context, the network 3 (FIG. 1) is representative of an Internet or Intranet. However, the network 3 (FIG. 1) may be implemented in many different forms, including both wire-based networks (e.g., fiber optic, cable, telephone, etc.) and wireless networks (e.g., microwave, RF, satellite, etc.). Similarly, LAN can also be embodied in different possible ways. The invention detailed herein is, hence, applicable to any processor based devices which need software access. Moreover, the present invention is also applicable to software security from piracy, formats requiring the storage of personal or secured information thereon. It is therefore contemplated that the appended claims will cover any such modifications or embodiments as fall within the true scope of the invention.

All of the U.S. Patents cited herein are hereby incorporated by reference as if set forth in their entirety.

References Cited
U.S. Pat. Documents

| | | | |
|---|---|---|---|
| 6,256,773 | July 2001 | Bowman-Amuah | 717/1 |
| 6,223,343 | April 2001 | Hopwood, et al | 717/11 |
| 6,195,796 | February 2001 | Porter | 717/11 |
| 6,173,446 | January 2001 | Khan, et al. | 717/11 |
| 6,141,698 | October 2000 | Krishnan, et al. | 709/331 |
| 6,067,622 | May 2000 | Moore | 713/200 |
| 5,960,196 | September 1999 | Carrier, III, et al. | 717/1 |
| 5,182,770 | January 1993 | Medveczky, et al | 705/56 |

What is claimed as being new and desired to be protected by Letters Patent of the United States as follows:

1. A method and system for preventing unauthorized use of a software product on a host computer system or any other process based hardware in association with a licensing system comprising the steps of:
at the beginning of installation or execution of a software product at a host computer system;
dynamically encrypting a portion of the unique serial number assigned to the software product and transmitting it along with a proper action request to the licensing system;
at the licensing system:
dynamically decrypting the received portion of the serial number and identifying the action requested;
comparing the dynamically decrypted portion of the received serial number with the stored serial number;
if the received portion matches with the stored portion, dynamically encrypting the same or another portion of the stored serial number of the software product along with an action response and transmitting it back to the host computer system;
if the received portion does not match with the stored portion, transmitting an error status message or code back to the host computer system;
at the host computer system:
dynamically decrypting the received portion of the serial number;
comparing the received portion with the stored portion of the serial number;
if the received portion matches with the stored portion, enable execution or proceed with the installation of the software product;
if the received portion does not match with the stored portion, disable the execution or installation of the software product; and
if an error status message or code received, inform the user by displaying the error message.

2. The method and system according to claim 1 wherein the transmitting portion of the software product serial number is randomly selected.

3. The method and system according to claim 1 wherein the method for dynamic encryption/decryption of digital information comprising the steps of:
at the host computer system and the licensing system before the start of encryption/decryption procedure:
means for assigning and mutually agreeing upon a pre-determined number of bits that are located at pre-determined and specific positions, called Function Bits, within a random number consisting of an arbitrary length;
means for defining a function pool containing any type of mathematical or logical functions of any complexity such that there exists a unique inverse mathematical or logical function for each of the functions defined in the said pool;
means for defining a number ‘M’ which indicates the total number of encryption/decryption rounds.
at the host computer system:
(a) means for generating a random number R1 of an arbitrary length
(b) means for identifying and sequentially arranging the pre-determined number of Function Bits located at the pre-determined and specific positions within the random number R1,
(c) means for sequentially arranging an array of Function Bits;
(d) means for selecting a set of Function Bits consisting of certain numbers in a pre-determined order;
(e) means for producing a numeric number value based on the selected Function Bits,
(f) means of selecting a mathematical or logical function from the function pool based on the numeric number value,
(g) means for encrypting a digital information segment through operating a mathematical or logical function selected from the function pool as described in step (f); and
(h) means for repeating step (d) through step (g) for ‘M’ number of times.

4. The method and system according to claim 3 wherein the Function Bits located within a random number of any length can be uniquely assigned and mutually recognized by the host computer system and the licensing system through the use of any mathematical or logical functions of any complexity.

5. The method and system according to claim 3 wherein the host computer system or the licensing system builds a decryption table, comprising the steps of:
(a) means for sequentially arranging an array of Function Bits contained in the received random number;
(b) means for selecting the Function Bits in a pre-determined order;
(c) means for selecting a mathematical or logical function from the function pool based upon the numeric number value of step (b);
(d) means for identifying the corresponding inverse function for the mathematical or logical functions as recognized in step (c);
(e) means for tabulating the identified inverse mathematical or logical function entries;
(f) means for repeating steps (b) through (e) for ‘M’ number of times and appending the inverse function entries resulting from each round into a tabular form of a decryption table.

6. The method and system according to claim 1 wherein the said method for dynamic decrypting of digital information between the host computer system and the licensing system or vice versa, the method comprising the steps of:
(a) means for receiving the encrypted digital information segment;
(b) means for decrypting the digital information segment with the last inverse mathematical function entry as found in the decryption table built in step (f) of claim 5;
(c) means for repeating the above step (b) until all the inverse mathematical or logical functions are exhausted as found in the said decryption table;

7. The method and system according to claim 1 wherein the host computer system and the licensing system initializes a dynamic encryption session comprising the steps of:
at the host computer system:
means for generating two random numbers R1 and R2;
means for treating R2 as a data segment and dynamically encrypting R2 through using R1;
means for transmitting R2_{(Enc.)} and R1 to the licensing system;
at the licensing system:
means for generating two random numbers R3 and R4;
means for treating R4 as a data segment and dynamically encrypting R4 through using R3;
means for transmitting R4_{(Enc.)} and R3 to the licensing system;

8. The method and system according to claim 1 wherein the host computer system and the licensing system encrypts the digital information segments comprising the steps of:
at the host computer system:
means for encrypting any subsequent digital information segments directed to the licensing system by using R4;
at the licensing system:
means for encrypting any subsequent digital information segments directed to the licensing system by using R2;

9. The method and system according to claim 1 wherein the host computer system and the licensing system establishes decryption session comprising the steps of:
at the host computer system:
means for decrypting the received random number R4 through the use of R3;
means for using the random number R2 to decrypt any digital information segments received from the licensing system;
at the licensing system:
means for decrypting the received random number R2 through the use of R1; and
means for using the random number R4 to decrypt any digital information segments received from the host computer system;

10. The method and system according to claim 3 wherein the method of selecting Function Bits is comprising the steps of:
(a) means for establishing a sliding window selector over an array of Function Bits;
(b) means for selecting a set of a pre-determined number of Function Bits from the said array; and
(c) means for advancing the sliding window selector over the Function Bits array to select another set of Function Bits in a pre-determined order.

11. The method and system according to claim 10 wherein the method of changing the bit values in an array of Function Bits through Insertion Bits, comprising the steps of:
(a) means for defining a pre-determined number and location of Insertion Bits in the shift register containing the array of Function Bits; and
(d) means for changing the bit values of the Insertion Bits.

12. The method and system according to claim 3 wherein the method of selecting the number ‘M’ which indicates encryption/decryption rounds, comprising the steps of:
(a) means for reading a pre-determined number of bits from an array containing Function Bits and calculating the binary equivalent number; and
(b) means for adding a pre-determined number ‘m’ into the results of step (a) to determine the number ‘M’.

13. The method and system according to claim 1 wherein the licensing system is adapted in a shape of a dongle with the ability to be connected to any port of a host computer system.

14. The method and system according to claim 1 wherein the licensing system is adapted to be installed on a remote computer system in software modules.

15. The method and system according to claim 1 wherein both the host computer system and the licensing system engage in executing fictitious processes, comprising:
at the host computer system:
(a) means for initializing a random number of fictitious processes;
(b) means for transmitting the results to the licensing system;
at the licensing system:
(a) means for establishing filters to block out any fictitious data traffic received from the computer system; and
(b) means for transmitting a string of random numbers to the host computer system.

16. A method and system for distributing credits through a licensing system to a host computer system or any other process based hardware, comprising;
requiring the host computer system to obtain a credit from the licensing system before operating a software product;
requiring the licensing system to decrement the credit availability in any manner after delivering a credit to the host computer system.

17. The method and system according to claim 16 wherein an authorized entity can utilize any method to change the number of available credits in a licensing system.

18. The method and system according to claim 16 wherein a first licensing system adapted in a first form interacts with a second licensing system adapted in a second form, comprising:
(a) means for “downloading” credits required for execution of a software product from the first form of the licensing system to the second form of the licensing system; and
(b) means for “uploading” credits required for execution of a software product from the first form of the licensing system to the second form of the licensing system.

19. The method and system according to claim 16 wherein a licensing system increment credit(s) in its credit pool through uninstalling a software product from a host computer system, comprising the steps of;
at the host computer system:
(a) means for transmitting a credit request to the licensing system during the un-installation process of the software product;
at the licensing system:
(a) means for verifying the un-installation process of the software product to be completed at the host computer system;
(b) if the verification is successful, means for incrementing the credit(s) in the credit pool; and
(c) if the verification fails, means for notifying the user with the proper error message.

20. The method and system according to claim 16 wherein a licensing system can recover credit(s) previously used for an installed software product on a hard drive which has become non-operational, the method comprising the following steps of:
at the host computer system:
(a) means for loading a software program into the computer memory to directly access pre-determined location and number of sectors on the hard drive containing the said software product;
(b) means for establishing a communication session between the said hard drive and the licensing system;
at the licensing system:
(a) means for directly writing a pre-determined set of data information on the said sectors of the hard drive;
(b) means for verifying the written information on the said sectors;
(c) if the verification process is successful, issuing a credit(s) in the credit pool of the licensing system;
(d) if not, generating an error message or code and transmitting it back to the computer system.

21. A method for running a software product on a computer or any other process based hardware, the method comprising the following steps:
transmitting credit request for execution of a software product through using dynamic encryption to a licensing system;
determining if a credit should be released for the execution of the software product by the licensing system;
if yes, releasing the credit through dynamic encryption by the licensing system to the said computer system;
if not, transmitting an error message or code back to the said computer system;
at the host computer system:
executing the software product if a credit is received;
disabling the software product if no credit is received.
